(19) United States
(12) Patent Application Publication
(10) Pub. No.: US 2013/0142591 A1
(43) Pub. Date: Jun. 6, 2013

(54) Fastening Element

(71) Applicant: Uwe Frank, Pfedelbach-Windischenbach (DE)

(72) Inventor: Uwe Frank, Pfedelbach-Windischenbach (DE)

(21) Appl. No.: 13/817,489

(22) PCT Filed: Aug. 23, 2011
(86) PCT No.: PCT/EP2011/064475

§ 371 Date: Feb. 18, 2013

(30) Foreign Application Priority Data
Aug. 24, 2010 (DE) 10 2010 039 669.9

(51) Int. Cl. F16B 35/00; F16B 15/00

(52) U.S. Cl. CPC F16B 35/005; F16B 15/00
USPC 411/386; 411/440

(57) ABSTRACT

A fastening element, which may be in the form of a blind rivet or screw, is intended to be driven into an unperforated workpiece. In its front region that is intended to be driven into the workpiece, it includes a punching section which is formed in a cylindrical manner and has a front end face which extends obliquely to the longitudinal axis. The punching section may be smaller in diameter than the body of the fastening element or else have the same diameter. The section between the end face and the outer side of the punching section forms a circumferential edge. On account of the oblique profile of the end face, this circumferential edge is arranged such that when the fastening element is driven in, the circumferential edge first of all strikes the metal sheet at a front point. At this front point, the circumferential edge is in the form of a cutting edge extending in the circumferential direction. Upon striking the workpiece, it first of all forms a cut which is then enlarged in both circumferential directions as the procedure continues.

The invention relates to a fastening element which is driven into a non-perforated underlying surface in an abrupt movement.

There is already known a gun rivet, which is driven into a non-perforated workpiece with the aid of a firing device. At its end facing the workpieces, the rivet mandrel thereof has a tip which can also be formed in a pyramid shape (EP 1085952). Such a tip, which is conventional in gun rivets, makes penetration into the non-perforated workpiece easier.

However, it has been found that in certain applications, the deformation, caused by such a tip, of the workpiece in the region of the fastening point leads to unsuitable results.

The invention is based on the object of creating a fastening element suitable for driving into a non-perforated workpiece, said fastening element having a simple structure and leading to less deformation of the workpiece in the region of the fastening brought about by the fastening element.

In order to achieve this object, the invention proposes a fastening element having the features mentioned in claim 1. Developments of the invention are the subject matter of dependent claims.

Thus, in the region of its front end facing the workpieces, the fastening element has no tip, but rather a punching section having an end face which is bounded by a circumferential edge. This end face, and thus also the circumferential edge bounding it, are not located in a plane which extends transversely to the longitudinal axis. However, the end face does not have to be planar; it can also have other shapes.

At least in the front region (tip), the circumferential edge is formed advantageously symmetrically about the tip as a cutting edge.

As a result of the formation according to the invention, the cutting edge of the end face hits the workpiece first of all at a point, such that the opening of the workpiece begins there. Upon further penetration of the front region of the punching section, all points of the cutting edge and then the rest of the circumferential edge gradually come into contact with the workpiece, such that the opening is produced gradually, in a similar manner to shearing. As a result, the workpiece is deformed less severely in the region of the opening and also there is no excessive braking of the fastening element during penetration. In addition, on account of the shearing of a part of the workpiece, a hole with a clean periphery is produced. Such a clean periphery does not tend to tear, as can occur in the case of a hole produced by a tip. This proves to be advantageous in particular when the workpiece consists of fabric, plastics material, woven fiber fabric or composite materials rather than the usually used metals, in particular steel.

In order that such a clean hole can be punched even under aggravated conditions, according to the invention it may be provided in a development for the front punching section of the fastening element to have a cylindrical, in particular circular-cylindrical outer contour.

In a further development of the invention, it may be provided for the punching edge to be formed by a section line between the end face of the fastening element and a cylindrical outer contour of the fastening element, preferably by the cylindrical outer contour of the punching section.

In a further development of the invention, it may be provided for the punching section to have a smaller cross section than the actual body of the fastening element. It has been found that the formation of a hole with a smaller cross section than corresponds to the cross section of the fastening element both leads to good results in the configuration of the fastening and also means that the effort for firing in such a fastening element does not become too large.

In order to achieve this, it may be provided according to the invention for a transitional section which establishes the transition between the larger cross section and the smaller cross section to be arranged and formed between the front punching section and the fastening element body.

This transitional section can then have various shapes. For example, the transitional section can extend in a conical manner, that is to say with a rectilinearly extending side line.

It is likewise possible and is proposed by the invention for the transitional section to extend in a ballistic manner, i.e. the side line to be convexly curved.

A further possibility proposed by the invention is for the transitional section to have a concavely curved side line.

In particular, it may also be provided for the side line of the transitional section to be composed of sections having different configurations, i.e. ballistic, conical and concave sections.

It has already been mentioned that the oblique profile of the end face is intended to lead to the circumferential edge that produces the hole striking the workpiece gradually or at different times. As a result, first of all that part of the circumferential edge that forms the cutting edge is intended to carry out a cutting operation and subsequently the rest of the circumferential edge is intended to carry out a shearing operation. This can be improved in a development in that the end face of the punching section is at a smaller angle to the longitudinal axis of the fastening element in the region immediately radially behind the cutting edge than in its remaining region. As a result, the cutting edge is sharper. For example, this can occur in that the end face is formed in a concave manner.

In particular, it may be provided for the front region of the punching section having the end face and the cutting edge to be produced from stainless steel, preferably by cold forming, what is known as pinching.

Further features, details and advantages of the invention will become apparent from the claims and the abstract, the wording of both of which is incorporated into the content of the description by reference, from the following description of preferred embodiments of the invention and by way of the drawing, in which:

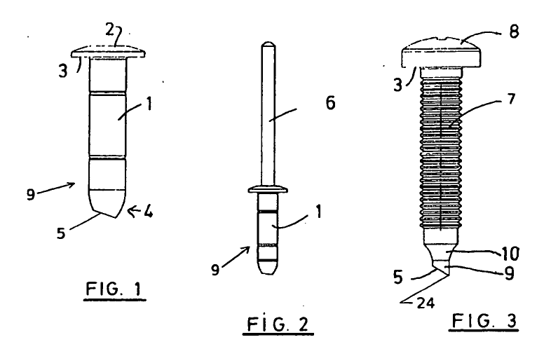

FIG. 1 shows the side view of a fastening element in the form of a hollow rivet;

FIG. 2 shows the side view of a fastening element in the form of a breakstem rivet;

FIG. 3 shows the side view of a fastening element in the form of a punch screw;

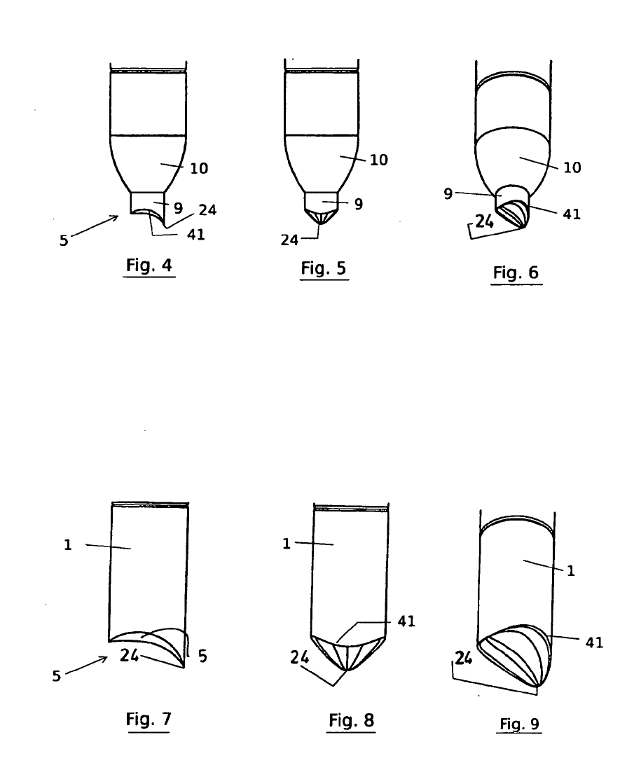

FIG. 4 shows a side view corresponding to FIG. 1 of the front part of a fastening element;

FIG. 5 shows a side view from a direction shifted through 90°;

FIG. 6 shows a perspective view of the embodiment of FIGS. 4 and 5;

FIG. 7 shows an illustration corresponding to FIG. 4 of yet another embodiment;

FIG. 8 shows the view of the embodiment of FIG. 7 from a direction shifted through 90°;

FIG. 9 shows a perspective illustration of the embodiment according to FIG. 7 and FIG. 8.

FIG. 1 shows, as an example of a fastening element proposed by the invention, a hollow rivet having a body 1, at one end of which there is formed a head 2. The head 2 protrudes radially beyond the cylindrical body 1 of the fastening element. Its underside forms an abutment shoulder 3 which comes into abutment with the top side of the workpiece in the fastened state. In the region of its front end 4 assigned to the workpiece, the fastening element has an end face 5, which is only indicated here.

A second example of the type of fastening element in which the invention can be used is illustrated in FIG. 2. This is a breakstem rivet, the body 1 of which looks exactly the same as the body 1 of the fastening element in FIG. 1. In the body 1 of the breakstem rivet there is located a rivet mandrel 6, which is pulled to form a closing head.

A third example of a fastening element on which the invention can be realized is illustrated in FIG. 3. This is a punch screw having a fastening element body 7, at one end of which there is arranged a screw head 8. The underside of the screw head forms an abutment shoulder 3 as in the previous fastening elements.

Formed in the region of the front end, that is to say that end of the fastening element of FIG. 3 that is remote from the screw head 8, is a punching section 9 which is bounded by an end face 5. Between the cylindrical body 7 of the fastening element and the likewise cylindrical punching section 9 there is formed a transitional section 10 which has a concavely curved side line in the example illustrated.

In the simplified illustrations in FIGS. 1-3, the front end face 5 and the cutting edge 24 are illustrated only schematically. The cutting edge 24 is more clearly apparent from the following figures. The cylindrical punching section 9 has a circumferential edge 41. This circumferential edge 41 bounds the end face 5. The cutting edge 24 is formed at the point where the end face 5 protrudes farthest forward, i.e. is at the greatest distance from the underside of the head 2 of the fastening element. This cutting edge extends naturally in the circumferential direction, since it is formed by a section of the circumferential edge 41. The end face immediately behind the cutting edge 24 is formed in a concave manner in the side view of FIG. 4. As a result, the cutting edge 24 is sharper than would be the case in a planar end face 5.

FIG. 5 shows the embodiment of FIG. 4 from the left in FIG. 4. It can be seen here that the cutting edge 24 has an arcuate shape in the side view. Here, too, it is ensured that the cutting edge strikes the workpiece to be machined first of all in a virtually point-like manner and then in a linear manner. In addition, a further edge, produced by the pinching of the tip, is formed in the middle of the end face 5.

It can be seen from viewing FIG. 5 and FIG. 6 together that, in a transverse direction, i.e. transversely to the illustration of FIG. 4, the end face 5 is also convexly curved. However, in order to form the cutting edge 24 in the region of the front end of the punching section 9, the concave form of FIG. 4 is decisive.

It is possible for the design, illustrated in FIGS. 4 to 6, of the front end of the fastening element to be present not only in fastening elements having a transitional section, but also in a fastening element in which the punching section has the same diameter as the body 1 of the fastening element. This applies, moreover, to most embodiments, but is illustrated graphically here once again. FIGS. 7 to 9 serve this purpose. Here, the same shape of both the end face and the cutting edge 24 is provided as in the previous embodiment.

Thus, when the punching section 9 strikes the workpiece to be machined, first of all a cut is produced in the circumferential direction with the aid of the cutting edge 24, said cut then being continued in both circumferential directions by the circumferential edge 41, which then acts as a punching edge.

1. A fastening element for firing in, having
a fastening element body (1, 7) which
has a head (2, 8) having an abutment shoulder (3) on its underside, and
a punching section (9) which forms the front end of the fastening element and
has an end face (15) which is bounded by a circumferential edge (41) and which
is not located in a transverse plane that extends perpendicularly to the longitudinal axis of the fastening element, wherein
the circumferential edge (41) is formed as a cutting edge (24), at least in its front region that is at the greatest distance from the abutment shoulder (3) of the head (2, 8).

2. The fastening element as claimed in claim 1, wherein the punching section (9) has a cylindrical, in particular circular-cylindrical outer contour.

3. The fastening element as claimed in claim 1, wherein the circumferential edge (41) is formed by a section line between the end face (15) and a cylindrical outer contour of the fastening element, preferably the cylindrical outer contour of the punching section (9).

4. The fastening element as claimed in claim 1, having
a transitional section (10) arranged between the front punching section (9) and the fastening element body (1, 7), wherein
the cross section of the punching section (9) is smaller than the cross section of the fastening element body (1, 7).

5. The fastening element as claimed in claim 4, wherein the transitional section (10) extends at least partially in a conical or concave manner.

6. The fastening element as claimed in claim 4, wherein the transitional section (10) is formed at least partially in a ballistic manner.

7. The fastening element as claimed in claim 1, wherein at least 10%, preferably 20%, at least 30%, at least 40% or at least 50% of the circumferential edge is in the form of a cutting edge, in particular symmetrically about a tip of the punching section.

8. The fastening element as claimed in claim 1, wherein the end face (5, 15) is at a smaller angle to the longitudinal axis of the fastening element in the region immediately behind the cutting edge (24) than in its remaining region, in order to reduce the angle of the cutting edge (24).

9. The fastening element as claimed in claim 1, wherein the front region of the punching section (9) having the end face (5, 15) and the cutting edge (24) is produced by pinching.

10. The fastening element as claimed in claim 1, wherein at least the punching section (9) consists of in particular cold work-hardened stainless steel.

11. The fastening element as claimed in claim 1, wherein the fastening element body is in the form of a screw or of a rivet body.

12. The fastening element as claimed in claim 1, wherein the cutting edge extends along the circumference or polygonally.
